(19) United States
(12) Patent Application Publication
(10) Pub. No.: US 2003/0012942 A1
(43) Pub. Date: Jan. 16, 2003

(54) Sol-gel preparation of porous solids using dendrimers

(75) Inventors: Gustavo F. Larsen, Lincoln, NE (US); Edgar Lotero, Lincoln, NE (US); Raffet Velarde-Ortiz, Lincoln, NE (US); Manuel Marquez-Sanchez, Glenview, IL (US); Ruben Spretz, Lincoln, NE (US)

Correspondence Address: SENNIGER POWERS LEAVITT AND ROEDEL, ONE METROPOLITAN SQUARE, 16TH FLOOR, ST LOUIS, MO, 63102, US

(73) Assignee: The Board of Regents of the University of Nebraska

(21) Appl. No.: 10/138,050

(22) Filed: May 3, 2002

Related U.S. Application Data
(60) Provisional application No. 60/288,339, filed on May 3, 2001.

(51) Int. Cl. B01J 23/38; B32B 3/26

(52) U.S. Cl. 428/304.4; 502/405; 502/325

(57) ABSTRACT

Methods for the sol-gel preparation of porous inorganic solids having highly uniform metal or metal oxide clusters embedded therein are provided. The porous solids are prepared by incorporating a metal ion-dendrimer complex into a gel and thermally decomposing the dendrimer to produce the solid. The invention further provides for novel inorganic solids exhibiting highly uniform porosity with metal or metal oxide clusters embedded therein.

### CROSS-REFERENCE TO RELATED APPLICATIONS

This application claims the benefit of U.S. provisional application Serial No. 60/288,339, filed May 3, 2001, the entire disclosure of which is hereby incorporated herein by reference.

### BACKGROUND OF THE INVENTION

The goal of sol-gel technology is to use low temperature chemical processes to produce net-shape, net-surface objects, films, fibers, particulates or composites that can be used commercially after a minimum of additional processing steps. Sol-gel processing can provide control of microstructures in the nanometer size range, i.e., 1 to 100 nm (0.001 to 0.1 μm), which approaches the molecular level. These materials often have unique physical and chemical characteristics.

Sols are defined as colloidal particles in a liquid. Colloids are nanoscaled entities dispersed in a fluid. Gels are viscoelastic bodies that have interconnected pores of submicrometric dimensions. A gel typically consists of at least two phases, a solid network that entraps a liquid phase. Sol-gel processing is the preparation of ceramic, glass or composite materials by the preparation of a sol, gelation of the sol, and removal of the solvent.

Dendrimers are highly branched, quasi-spheroidal polymers. Dendritic polyamines such as poly(amido)amine (PAMAM) and poly(propylene)imine (DAB) dendrimers exhibit an affinity for chelating transition metal ions in solution. DAB-Am-n polyamines have a 1,4-diaminobutane (DAB, or putrescine, NH₂(CH₂)₄—NH₂) core and n represents the number of terminal amine groups. Two —(CH₂)₃NH₂ groups can be attached to each terminal nitrogen atom of the core molecule, to form the so-called “generation 1” tetradentate dendrimer, or DAB-Am-4. Further growth toward higher “generations” readily suggests itself, as each of the four terminal primary amine groups in DAB-Am-4 can also be subjected to further —(CH₂)₃NH₂ branching. The paired terminal amine groups act as ligands which can form a metal ion-dendrimer complex comprising multiple metal ions, the number of metal ions in the metal ion-dendrimer complex being equivalent to one-half of the number of terminal nitrogen atoms. The PAMAM family is also a versatile dendrimer class able to chelate many metal ions per molecule.

The present invention relates generally to methods for preparing porous inorganic solids and porous solids comprising highly uniform clusters of metals or metal oxides embedded in an inorganic matrix. The products of these methods are useful in the field of semiconductors and as supports for heterogeneous catalysis, particularly for small molecule catalysis (e.g., reduction of nitrogen oxide gases in the presence of hydrocarbons) and other applications requiring entrapment of the metal and metal oxide clusters to prevent undesirable phenomena such as agglomeration or high-temperature sintering. More particularly, in accordance with the present invention, dendrimers are introduced into sol-gel processing techniques, to produce porous solids exhibiting a highly uniform pore size distribution. Moreover, by using dendrimers as chelating templates in sol-gel processing, it has been found that porous solids comprising substantially uniform clusters of metals or metal oxides embedded in an inorganic matrix can be formed with or without spatial ordering.

### SUMMARY OF THE INVENTION

Among the several objects of this invention, therefore, may be noted the provision of porous solids comprising metal or metal oxide nanoparticles or clusters embedded in an inorganic matrix with or without spatial ordering and a method for preparation of such materials; the provision of such materials exhibiting a highly uniform porosity and particle size distribution of the metal or metal oxide clusters; the provision of a method wherein a dendrimer is used as a chelating template to incorporate the metal or metal oxide clusters into the inorganic matrix; the provision of such a method which is applicable to a variety of transition metals; and the provision of such a method wherein the metal nanoparticles embedded in the inorganic matrix may be in different oxidation states.

Briefly, therefore, the present invention is directed to a method for preparing a porous solid comprising metal or metal oxide clusters embedded in an inorganic matrix. The method comprises combining a dendrimer, metal ions, a sol-gel precursor and a solvent to form a gel containing a chelated metal ion-dendrimer complex. The gel is then heated to thermally decompose the dendrimer and produce the porous solid comprising the inorganic matrix having metal or metal oxide clusters embedded therein.

The present invention is further directed to a method for preparing a porous solid having metal clusters supported thereon, the method comprises combining a dendrimer, a sol-gel precursor and a solvent to form a gel comprising the dendrimer. The gel is then heated to thermally decompose the dendrimer and produce the porous solid. Metal clusters are then deposited onto the porous solid.

In accordance with a still further embodiment of the present invention, a porous inorganic solid comprising metal clusters is provided. The porous inorganic solid has spheroidal pores having a diameter from about 10 to about 40 angstroms. The spheroidal pores have a pore size distribution such that the diameter of at least about 95% of the spheroidal pores is within 0.5 nm of the average diameter of the spheroidal pores.

Other objects and features of this invention will be in part apparent and in part pointed out hereinafter.

### BRIEF DESCRIPTION OF THE DRAWINGS

FIG. 1A is a schematic representation showing the spatial ordering of a Cu₆O₁₆⁻²⁰ cluster as prepared in Example 1.

FIG. 1B is a schematic representation showing the spatial ordering of Cu atoms in the second shell of tenorite.

FIG. 1C is a schematic representation showing the spatial ordering of CuO₆⁻¹⁰ center of tenorite.

FIG. 2 is a photoelectromicrograph showing the TEM analysis of embedded Cu_{y}Oₓ clusters as prepared in Example 1.

FIG. 3 is a photoelectromicrograph showing the TEM analysis of ZnAs/G5 prepared from DAB-Am-64 in Example 2.

FIG. 4 is a graph illustrating the interlayer spacing determined by XRD as a function of dendrimer generation in Example 2.

FIG. 5 is a graph illustrating the Ar pore size distributions for the porous silica solids prepared from DAB-Am-32 and DAB-Am-64 dendrimers in Example 3.

FIG. 6 is a graph illustrating the XRD results for the porous silica solids prepared from DAB-Am-32 and DAB-Am-64 dendrimers in Example 3.

FIG. 7 is a graph illustrating the TPO results for the preparation of the porous silica solids prepared from DAB-Am-32 and DAB-Am-64 dendrimers in Example 3.

FIG. 8 is photoelectromicrograph showing the TEM analysis of Pt metal clusters as prepared in Example 4.

### DETAILED DESCRIPTION OF THE PREFERRED EMBODIMENTS

In accordance with the present invention, it has been discovered that by employing a dendrimer in sol-gel processing, porous solids exhibiting a highly uniform and selectively variable pore size distribution may be produced.

The dendrimers employed have well-defined, branched and compartmentalized, preferably quasi-spheroidal, structures. Preferably, the dendrimer employed comprises terminal amine groups and is at least a second generation dendrimer (i.e., the dendrimer preferably comprises a polyamine dendrimer). As discussed in greater detail below, amine dendrimers are macrochelating agents for a wide variety of metals that have a strong affinity for amine ligands, including nickel, platinum, palladium, copper, zinc, cobalt, iron, silver and gold, and are particularly useful in certain embodiments of the present invention. Examples of suitable polyamine dendrimers include PAMAM and DAB-Am-n dendrimers, wherein n can be 4, 8, 16, 32, 64 and higher. In accordance with a preferred embodiment, the dendrimer comprises a DAB-Am-n dendrimer, especially DAB-Am-64.

The sol-gel processing techniques used in the practice of the present invention are largely conventional and well understood by those skilled in the art. Generally, the gel comprising a dendrimer is formed by combining the dendrimer, a sol-gel precursor and a solvent. The order and manner in which these components of the gel are combined may vary. For example, gel formation can be achieved in a one-pot synthesis. Alternatively, a solution comprising the dendrimer and a second solution comprising the sol-gel precursor may be prepared and the two solutions subsequently combined.

Typical sol-gel precursors comprise a metal or metalloid selected from the group consisting of silica, titanium, zirconium, vanadium and aluminum. Preferably, the sol-gel precursor is a metal or metalloid alkoxide. In accordance with a preferred embodiment a silica alkoxide such as tetraethylorthosilicate (TEOS) is employed as the sol-gel precursor such that the porous solid produced comprises an inorganic silica matrix.

The solvent used in forming the gel may comprise lower primary alcohols such as methanol, ethanol, propanol and butanol. For example, a dendrimer solution can be prepared using 2-propanol as the solvent and that solution combined with a methanolic solution of the sol-gel precursor. Typically, the ratio of dendrimer in solution ranges from about 1:2 to about 1:6 grams of dendrimer per gram of solution, preferably about 1:4 grams of dendrimer per gram of solution. In the case of silica alkoxide sol-gel precursors and PAMAM and DAB-Am-n dendrimers, the sol-gel precursor/dendrimer molar ratio is typically from about 10 to about 500, preferably from about 40 to about 240. The number of silicon atoms per surface amine group in the PAMAM and DAB-Am-n dendrimer molecule is typically, from about 1 to about 10, preferably from about 2 to about 8.

A variety of catalyst can be used to aid in the gelation of the dendrimer/sol-gel precursor mixture. These include, but are not limited to, aqueous hydrochloric, nitric, acetic, formic, and sulfuric acids, aqueous solutions of alkaline and alkaline earth hydroxides (e.g., CsOH) as well as organic bases. Normally the basicity of the dendrimer itself is sufficient to initiate the gelation process.

Generally, the dendrimer, sol-gel precursor and solvent are combined in a manner such that gelation occurs, for example, by controlled hydrolysis and polycondensation of an alkoxide sol-gel precursor to form the gel comprising the dendrimer. The gel is heated (i.e., calcined) to thermally decompose the dendrimer and produce the porous solid. Preferably, solvent is removed from the gel (i.e., the gel is dried) to form a gel precipitate prior to calcination. For example, the gel may be aged for a period of about 2 to about 20 hours, preferably for about 3 hours in a closed container followed by about 12 hours in an open container, at a temperature of from about 40° C. to about 90° C., preferably about 70° C. The gel is then oven dried at a temperature of from about 100° C. to about 120° C., preferably about 110° C., to form the gel precipitate. The resulting gel precipitate, which still contains the dendrimer, is thereafter subjected to oxidative elimination by heating to a temperature of at least about 500° C. in an oxidizing environment. Oxidative elimination results in thermal decomposition and volatilization of the dendrimer and other organic materials present. Preferably, the dried gel precipitate is triturated to a fine powder and heated to a temperature of from about 500° C. to about 800° C., more preferably from about 550° C. to about 650° C.

The proper protocol for drying and calcination of the gel precipitate to produce the desired porous solid may be readily determined through direct experimentation. Typically, the gel precipitate is heated using a programed temperature profile including gradual temperature changes (i.e., substantially linear with respect to time) and constant temperature plateaus. Preferably, the gel precipitate is heated in an oxygen-containing gas stream and the composition of the off-gas may be monitored to determine the endpoint of the calcination step. For example, mass spectrometric analysis of gases evolved during the drying and calcination shows that a complex decomposition pattern takes place involving the evolution of olefinic fragments, carbon monoxide, alkanes, alcohols and nitrogen-containing species from the gel, with alcohol and carbon monoxide resulting from the reactive desorption of alkoxy groups still present in the gel precipitate. Likewise, during calcination, carbon dioxide, water and volatilized organics are further evolved from the gel precipitate. Heating is stopped when no further evolution of dendrimer decomposition products are detected.

The porous inorganic solids produced by the present invention are characterized as having a highly uniform and selectively variable porosity. The pore structure is believed to be comprised of nanopores (i.e., pores having a diameter of about 10 angstroms) and larger pores which form a network of interconnected channels within the solid such that the interior surface of the solid is accessible to properly sized materials. More particularly, by incorporating a dendrimer into the gel and subsequently removing it from the gel precipitate by thermal decomposition, the dendrimer acts as a porogen which produces a substantial pore volume attributable to spheroidal pores having a diameter of from about 10 to about 40 angstroms, depending on the size of the dendrimer employed, and preferably from about 15 to about 30 angstroms. For example, the pore diameter may be controlled and tuned as desired for a particular application by increasing or decreasing the generation of the dendrimer utilized in the gel synthesis (i.e., varying n in the case of DAB-Am-n dendrimers). Advantageously, the spheroidal pores formed in the inorganic solid upon thermal decomposition of the dendrimer are characterized as being highly uniform and exhibit a pore size distribution such that the diameter of at least about 95% of the spheroidal pores is within 0.5 nm of the average diameter of the spheroidal pores. Typically, the inorganic solid has a pore volume of at least about 0.2 cc/g and preferably from about 0.2 cc/g to about 2.0 cc/g. In accordance with a preferred embodiment of the present invention, at least about 60% of the pore volume is attributable to spheroidal pores having a diameter of from about 10 to about 40 angstroms, more preferably from about 15 to about 30 angstroms.

The inorganic solids of the present invention may be used as supports for a metal-containing catalytic active phase. The metals used in such an application are selected to provide the desired catalytic effect and may be transition metals such as copper, zinc, nickel, platinum, palladium, cobalt, iron, silver and gold. For example, metal clusters may be loaded onto the porous inorganic solid using conventional “incipient wetness impregnation” (IWI) techniques. Typically, in water, alcohol, or a aqueous alcohol solution. For example, a nitrate salt of a transition metal (e.g., Cu(NO₃)₂) may be dissolved in a lower alcohol such as methanol, ethanol, propanol or butanol. It is important to note that the use of higher alcohols or water as a solvent for the transition metal ion may be less desired in some situations. For example, the use of higher alcohols as solvents for copper ion may lead to unstable, turbid Cu²⁺ solutions. The solid is then contacted with a sufficient quantity of the metal ion-containing solution to just fully wet it, without leaving a macroscopically visible excess of liquid phase. The metal ions in solution are then deposited into the pores of the solid to provide a porous solid supporting metal-containing clusters.

In another embodiment, dendrimers are used as a chelating template in sol-gel processing, to produce a porous solid having uniform nano-sized clusters of metals or metal oxides embedded in an inorganic matrix with or without spatial ordering.

A gel containing a chelated metal ion-dendrimer complex is formed by combining a dendrimer, a sol-gel precursor and a solvent as described above along with a source of metal ions (e.g., a nitrate, sulfate or chloride salt of the metal). The dendrimer is selected to contain ligand structures exhibiting an affinity for chelating the desired metal to be embedded in the porous solid. Dendritic polyamines such as PAMAM and DAB dendrimers are well-known macrochelating agents for a wide variety of transition metals, including nickel, platinum, palladium, copper, zinc, cobalt, iron, silver and gold. Other suitable dendrimer-metal pairs for use in the practice of the present invention will be apparent to those skilled in the art. The concentration of metal or metal oxide clusters in the porous solid may be selectively varied by increasing or decreasing the generation of the dendrimer employed (i.e., increasing or decreasing the number of ligand sites in the dendrimer molecule) as well as by increasing or decreasing the concentration of the dendrimer in the gel preparation. For most applications, the dendrimer used to form the metal ion-dendrimer complex is suitably at least a second generation dendrimer and preferably at least a fourth generation dendrimer such as DAB-Am-32 or DAB-Am-64.

The order and manner in which the components of the gel and metal ion-dendrimer complex are combined may vary. For example, the dendrimer may be combined with the sol-gel precursor in a solvent to form a solution comprising a colloidal dendrimer matrix and the solution combined with a second solution comprising the metal ions. Alternatively, a one pot synthesis of the gel containing the metal ion-dendrimer complex may be possible in which the dendrimer, the sol-gel precursor, metal ions and solvent are combined in a single step. Preferably, the dendrimer is combined with a source of the metal ions in a solvent to first form a solution comprising the chelated metal ion-dendrimer complex and then that solution is combined with a second solution comprising the sol-gel precursor. Optionally, the dendrimer may first be dissolved in a solvent before combining the dendrimer solution with a solution of the metal ions to form the chelated metal ion-dendrimer complex.

Once formed, the gel comprising the metal ion-dendrimer complex is heated to thermally decompose the dendrimer and produce a porous solid comprising an inorganic matrix having metal or metal oxide clusters embedded therein. Preferably, solvent is removed from the gel to form a gel precipitate comprising the chelated metal ion-dendrimer complex and then the gel precipitate is heated to thermally decompose the dendrimer. As described above, solvent removal may be achieved by aging the gel in an open or closed container at a temperature of from about 400° C. to about 900° C. followed by subjecting the gel to low temperature heating at a temperature of from about 100° C. to about 120° C. The gel precipitate is then calcined to remove the dendrimer and leave behind a porous inorganic solid having metal or metal oxide clusters embedded therein. Calcining of the gel precipitate containing the metal ion-dendrimer complex is achieved by heating in an oxidizing environment (e.g., oxygen-containing gas stream) to a temperature of at least about 500° C., preferably from about 500° C. to about 800° C., until oxidative elimination of the organic components of the gel precipitate is complete. Preferably the gel precipitate is triturated to a fine powder prior to calcination.

The porous solids produced by calcining the gel precipitate comprising the metal ion-dendrimer complex have a dispersion of metal or metal oxide clusters embedded in the resulting inorganic matrix. The embedded clusters exhibit a highly uniform particle size distribution such that 95% of the clusters have a diameter from about 1 nm to about 5 nm. In general, the particle size of the metal or metal oxide clusters can be selectively increased by increasing the size of the dendrimer employed. In accordance with a preferred embodiment of the present invention, the particle size distribution exhibited by the metal or metal oxide clusters is such that the diameter of 95% of the clusters is within 0.5 nm of the average cluster diameter. optionally, metal oxide nanoparticles embedded in the inorganic matrix of the porous solid may be chemically reduced to a lower oxidation state (e.g., the metallic or zerovalent state) by contacting the porous solid with molecular hydrogen at elevated temperature or contacting the porous solid with a solution of lithium aluminum hydride or sodium borohydride.

### EXAMPLES

The invention is described hereinafter in more detail by way of examples. The following examples merely further illustrate and explain the present invention and should not be construed in a limiting sense.

### Example 1

### Preparation of Copper Metal Clusters Embedded in a Silica Matrix from a Dendrimer-Metal Ion Complex

This example demonstrates the preparation of copper metal clusters embedded in a silica matrix. The method comprises forming a dendrimer-metal ion complex, loading the dendrimer-metal ion complex into a silica matrix, and removing the dendrimer from the silica.

DAB-Am-64 (250 mg) was dissolved in 2-propanol (1.3 ml) followed by the addition of a methanolic solution of Cu(NO₃)₂.2.5H₂O (0.03M; 0.5 ml), and deionized water (3.0 ml) to form a solution comprising a dendrimer-copper ion complex having a molar ratio of about 16:1 Cu²⁺:DAB-Am-64. The solution had a classical deep blue coloration associated with Cu²⁺ amine complexes.

The dendrimer-copper ion complex was then trapped in a gel matrix by adding a methanolic solution of tetraethyl orthosilicate (TEOS) (3.08M; 1.0 ml) to the copper-loaded dendrimer solution. The mixture was then aged in a closed container at 75° C. (348 K) for 3 hours and then aged in an open container for an additional 12 hours at 75° C. (348 K) in an open container. The resulting solid was then oven dried at a temperature of 100° C. (373 K) for 12 hours. The solid, which was a deep green color, was ground to a fine powder.

The powder was then further dried at 110° C. for 30 minutes. Subsequently, the powder was placed in a quartz U-tube reactor, for calcination and to thermally decompose the dendrimer. The powder was heated externally while flowing air through it. A linear heating ramp was programmed, the dendrimer decomposition pattern was followed by means of a mass spectrometer, and heating was interrupted when no further evolution of dendrimer decomposition products was detected.

The above method was repeated using different quantities of reactants to form copper metal clusters from dendrimer-copper ion complex solutions having molar ratios of Cu²⁺ to DAB-Am-64 dendrimer of 4:1 Cu²⁺:DAB-Am-64, 8:1 Cu²⁺:DAB-Am-64 and 32:1 Cu²⁺:DAB-Am-64.

The solids obtained in the experiment were underwent Extended X-ray Absorption Fine Structure (EXAFS) Analysis to determine the size and structure of the copper clusters. EXAFS analysis and data reduction was completed using the WinXAS program suite, which has an interface to generate theoretical phase and amplitude functions from the FEFF 8.10 program as described by Rehr et al. in Phys. Rev., B62, 7665 (2000). Input files for FEFF 8.10 were generated using the WebATOMS database, or by building molecular models of simple geometries whose Cartesian coordinates were exported into a FEFF input file. In all fitting procedures, the amplitude reduction factor (So²) was set to one and only SS paths were considered. Fitting of the EXAFS data was done in k space.

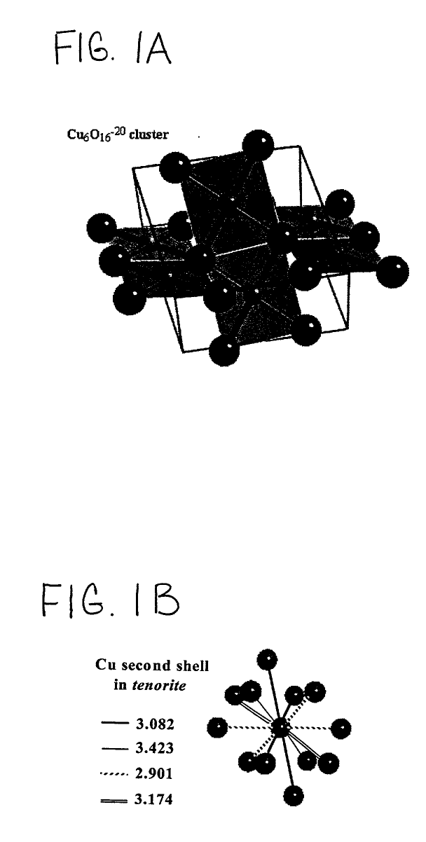

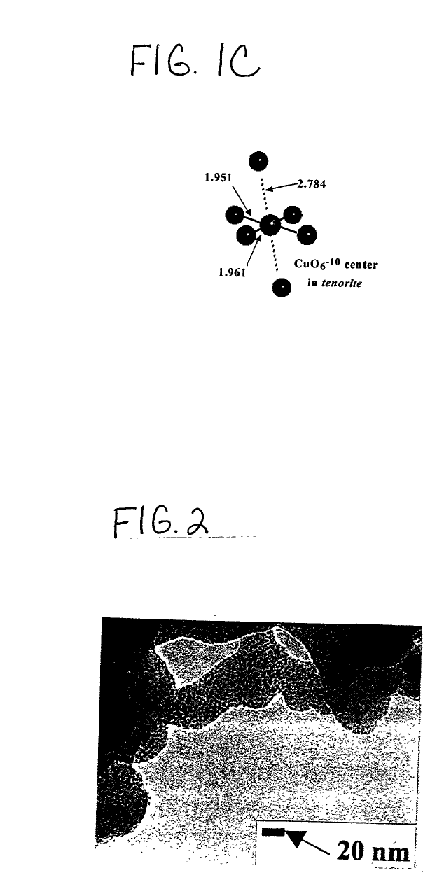

Table 1 shows the EXAFS data observed from a calcined (Cu²⁺)₁₆/DAB-Am-64/SiO₂ solid, which was prepared as described above, and from which one skilled in the art from can infer an average Cu_{y}Oₓ cluster size. The second-shell results in Table 1 generally corresponds to a Cu₆O₁₆⁻²⁰ cluster having an average Cu—Cu coordination number (i.e., the average number of Cu atoms nearest to the Cu center) of 3.3 as shown in FIG. 1A. As a comparison, a Cu₁₃ cluster as shown in FIGS. 1B and 1C (O atoms have been omitted for clarity) is the “quasi-spherical” tenorite cluster that is closest in size to the preset dendrimer loading of 16 Cu atoms per dendrimer. The average Cu—Cu second shell coordination number of the Cu₁₃ tenorite cluster is 5.2.

Given that EXAFS is a bulk-averaging technique, the samples were also analyzed with a transmission electron microscope (TEM). The TEM studies were conducted in the bright field mode with a JEOL JEM2010 microscope at 200 keV beam energy. TEM analysis resulted in a clear particle size distribution picture showing embedded Cu_{y}Oₓ clusters of substantially homogeneous size as depicted in FIG. 2.

Finally, the conventional Brunauer-Emmet-Teller (BET) specific surface areas were determined for the calcined solids. The BET surface area was derived from nitrogen physisorption data at −196° C. (77 K), using a custom-built greaseless glass line equipped with a Baratron pressure transducer, mechanical and diffusion pumps, and bakeable three O-ring Teflon stopcocks. Prior to the measurements, the sample was evacuated for 1 hour at 60° C. (383 K). The specific surface area of the (Cu²⁺)₁₆/DAB-Am-64/SiO₂ calcined materials were determined by conventional BET surface area analysis to be 290.5 m²/g. This compared to a specific surface area of 416.0 m²/g which was determined for a blank material (a material prepared in accordance with Example 1 without a copper metal).

TABLE 1
Second-shell EXAFS results for calcined CuD16.

| Parameter | k-space |
|---|---|
| Coord. No. (N) | 3.7 |
| Distance, R | 2.97 |
| (Å) | |
| Δσ (Å²) | 0.0015 |
| Rel. Res. | 26.00 |
| Error | |

Note: A single Cu—Cu second sub-shell reference from tenorite (natural CuO, R = 2.9007 Å, N = 4.0) was used as a reference.

### Example 2

### Preparation of Transition Metal Clusters by Contacting a Metal Ion Solution with a Dendrimer/Zinc Arsenate Composite

This example demonstrates the incorporation of a transition metal with an affinity for a dendrimer into a dendrimer/matrix composite followed by the removal of the dendrimer to form a porous solid having metal clusters embedded therein. The selected matrix for this example was zinc arsenate.

The experiment was conducted by preparing five samples, each using a different generation dendrimer. The amount of DAB-Am-n dendrimer (and obviously, its generation suffix “n”, which determines dendrimer size) was changed in each preparation. The molar ratios of dendrimer were likewise changed in each preparation, to preserve the number of —NH₂ terminal group equivalents in the dendrimer (i.e., its outer-shell nitrogen atoms) available for the reaction. Thus, the ratio of (terminal NH₂):ZnO:As₂O₅:H₂O of 1:1:0.5:691 remained constant in each preparation. Table 2 summarizes the reaction conditions and ingredients for each sample preparation.

In a typical preparation, As₂O₅ (1.2 mmol) was placed in water (20 mL) in a high-density polyethylene (HDPE) bottle to form a suspension. DAB-Am-64 dendrimer (0.0375 mmol comprising 2.4 mmol terminal NH₂ groups) was dissolved in a solution of water (4 mL) and 50 weight percent CsOH (1.2 mL) and added to the suspension. The HDPE bottle was placed in an oven at 70° C. until the oxide phase was completely dissolved and the solution was cooled to room temperature. After cooling, a solution of Zn(NO₃)₂.6H₂O (2.4 mmol) in water (5 mL) was added and a white precipitate formed. The suspension was shaken without removing it from the HDPE container, and placed in an oven at 70° C. for 5 days. The white precipitate was filtered, washed with water and finally dried at ambient conditions on a warm metal surface (35° to 45° C.).

Second Metal Loading

To load the dendrimers trapped in the zinc arsenate (ZnAs) matrix with different metal ions (e.g., Ni, Cu, Co, Pt, Au, Ag, etc.), metal ion salt solutions (e.g., nitrates) are employed to “impregnate” the dendrimer/zinc arsenate composites. The so-called “incipient wetness impregnation” (IWI) method consists of contacting a powdered solid with a quantity of liquid that is just enough to fully wet it, without leaving a macroscopically visible excess of liquid phase. The IWI technique is used to load the immobilized dendrimers with metal ions. Given the dendrimers' affinity for such ions through their amine (nitrogen) groups, selective chemical deposition of the target ion in the dendrimer is achieved.

As an example, a methanol solution of cobalt nitrate was used for the IWI method on the zinc arsenate composites listed in Table 1. The methanol was then evaporated at room temperature under vacuum for one hour.

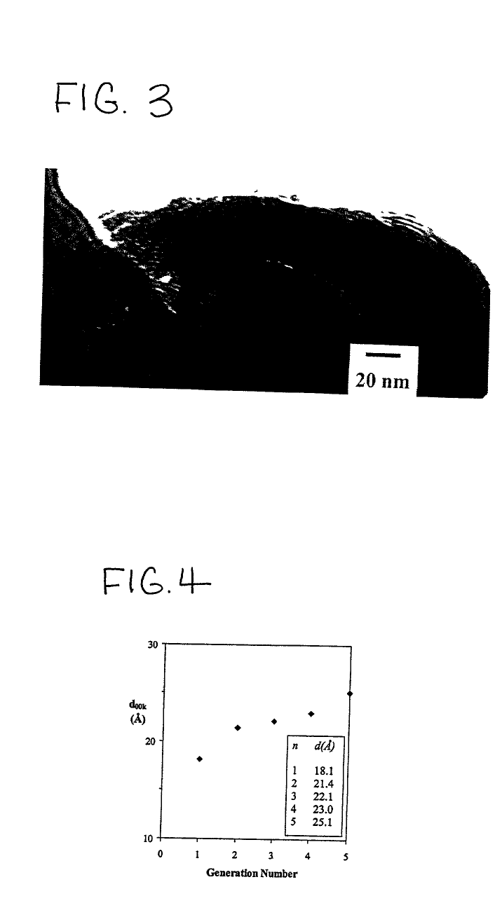

The dendrimer was then removed from the cobalt-containing ZnAs composites as described above in Example 1 to produce a layered material having cobalt metal clusters therein. On thorough inspection of these materials particles with TEM as described in Example 1, a “side” view was obtained to their layered structures. FIG. 3 shows a TEM image for the sample prepared from DAB-Am-64 (ZnAs/G5). The low-temperature synthesis yields solids that display some level of folding of the ZnAs/dendrimer sheets and occasionally, defects such as sheet branching. Inspection of magnified TEM images in several regions, where layer stacking is close to perfect, reveals a repetitive distance of 26.5 Å (i.e., one solid ZnAs layer plus the dendrimer-filled interlayer spacing) in the G5-based material. Despite the estimate of interlayer distance being more crude than the data obtained from X-ray diffraction (XRD) analysis (see below), FIG. 3 provides direct confirmation of the presence of a layered phase.

The materials were further analyzed by X-ray diffraction (XRD) using a computer-interfaced Rigaku DBMax II instrument with a Cu—K source. FIG. 4 illustrates the interlayer spacing determined by XRD as a function of dendrimer generation.

Finally, outside chemical analysis was performed on the layered materials by Galbraith (Knoxville, Tenn.). The samples were analyzed based on zinc arsenate and DAB dendrimers of different generations. Excluding non-dendrimer species, the chemical formula for the ZnAs/G5 sample was determined to be G5_{0.039}As₂O₁₀Zn₅·3H₂O, the chemical formula for the ZnAs/G4 sample was determined to be G4_{0.074}As₂O₁₀Zn₅·4H₂O, and the chemical formula for the ZnAs/G3 sample was determined to be G3_{0.13}As₂O₁₀Zn₅·4H₂O.

It is important to note that removal of the dendrimer can alternatively be achieved at a lower temperature (from about room temperature to about 200° C.) in the presence of ozone, or hydrogen peroxide. The choice of dendrimer removal method will depend on the metal ion that is incorporated in the dendrimer; however, upon oxidation of the dendrimer, its several or many metal ions per dendrimer molecule will coalesce into a small metal oxide cluster, with sizes in the 1-3 nanometer range. In the case of layered materials, for example the ZnAs material prepared above, metal oxide “pillars” are created.

| | Dendrimer | Dendrimer | As₂O₅ | Zn(NO₃)₂. | Aging | Aging | |
|---|---|---|---|---|---|---|---|
| Sample | Generation | (mmol) | (mmol) | 6H₂O | Temp (° C.) | Time (days) | pHi-pHf |
| ZnAs/G5 | 5 | 0.0375 | 1.2 | 2.4 | 70 | 5 | 10.24-10.52 |
| ZnAs/G4 | 4 | 0.0750 | 1.2 | 2.4 | 70 | 5 | 10.28-10.44 |
| ZnAs/G3 | 3 | 0.1500 | 1.2 | 2.4 | 70 | 5 | 10.32-10.40 |
| ZnAs/G2 | 2 | 0.3000 | 1.2 | 2.4 | 70 | 5 | 10.11-10.23 |
| ZnAs/G1 | 1 | 0.6000 | 1.2 | 2.4 | 80 | 5 | 9.8-9.7 |

### Example 3

### Preparation of a Nanoporous Silica Matrix Using a Dendrimer Template

This example demonstrates the preparation of a nanoporous silica matrix using a dendrimer template. Tetraethyl orthosilicate (TEOS) (1.024 g) was mixed with a mixture of 1-propanol and DAB-Am-64 (1.61 g), which consisted of 0.25 g of dendrimer per gram of solution. Anhydrous methanol (0.57 g) was also added to the TEOS/dendrimer/1-propanol mixture. The mixture was heated for 5 minutes in a closed 10 ml vial at 100° C. (373 K), wherein partial gelatin occurred. The gel was then acidified by adding a solution of 0.12 N H.L. (0.25 g), and subsequently aged in a closed container for 12 hours at 70° C. (343 K). The resulting solid was oven-dried at 100° C. (373 K) for 20 hours.

To remove the dendrimer template and form the ultimate porous silica matrix, the solid was dried at a high temperature by heating in a quartz U-tube reactor under flowing nitrogen for 3 hours at 530° C. (803 K), which produced a deep brown powder. The powder was then calcined by heating under flowing air from room temperature to a temperature of 560° C. (833 K), which was maintained for a period of 2 hours.

It is important to note that the choice in drying and calcination protocols was not in any way arbitrary. Mass spectrometric analysis of gases evolved during the high-temperature drying/curing step shows that a complex decomposition pattern takes place involving the evolution of olefinic fragments, carbon monoxide, alkanes, alcohols and N-containing species. Alcohol and carbon monoxide result from the reactive desorption of alkoxy groups still present in the oven-dried sample. During calcination, carbon dioxide and water evolved, and the choice of a plateau temperature of 560° C. (833 K) was based on the observation that no carbon-containing gases evolved beyond that temperature.

The thermal decomposition patterns of the materials were determined using a computer-interfaced MKS mass spectrometer (MS) was used. The experimental setup, consisted of a flow-through cell and associated mass-flow and temperature controllers. In brief, the experiment consisted of re-drying samples at 110° C. (383K) for 30 minutes prior to the TPO runs. Typically, 0.08 g were placed in the TPO cell as a 1:2 sample:SiO₂ (Fluka, nonporous) mixture, along with a preheating bed of nonporous α-Al₂O₃. A 1:1 He/UHP air feed flow (40 cm³/min) was set and the gas phase was sampled for MS analysis.

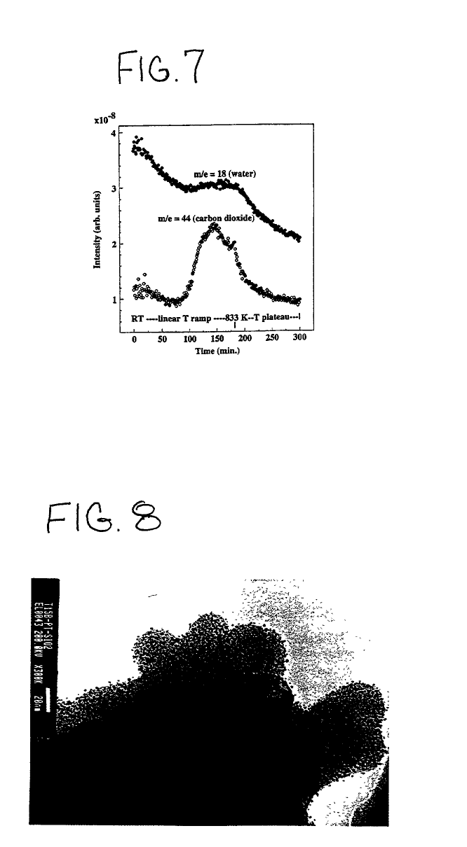

The temperature programmed oxidation (TPO) of DAB-Am-64/ silica composites is shown in FIG. 7. The TPO analysis demonstrated that temperatures as high as 477° C. (750K) were required to effect dendrimer removal under flowing air.

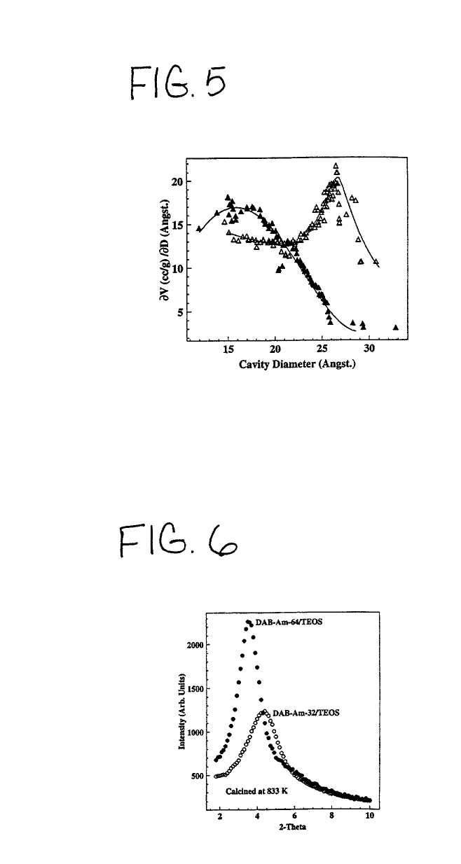

The calcined solid was subjected to Ar adsorption to determine pore size. The Ar adsorption isotherms were obtained at −196° C. (77 K) on a computer-interfaced custom-built adsorption line from Porous Materials, Inc., Ithaca, N.Y. Data analysis used the equations proposed by Chen and Yang in Chem. Eng. Sci., 49, 2599 (1994) in the form of a Fortran 77 code, to model the adsorption of gases in spherical pores by a modified Horvath-Kawazoe (HK) approach. A coverage-dependent term, as proposed by Chen and Yang, was incorporated into the modeling of spherical cavities. Polarizability and magnetic susceptibility data for both Ar and the oxide ion were taken from literature. FIG. 5 shows the Ar pore size distributions for the porous silica materials prepared from DAB-Am-32 and DAB-Am-64 dendrimers according to the procedure described above.

Additional evidence of the void size created by removal of the dendrimer was obtained by XRD analysis as described in Example 2. The XRD low angle reflections shown in FIG. 6 are consistent with the cavity diameters determined from the Ar adsorption data.

### Example 4

### Preparation of Platinum Metal Clusters Embedded in a Nanoporous Silica Made with a Dendrimer Template

This example demonstrates the preparation of platinum metal clusters embedded in a porous silica. The experiment consisted of forming a nanoporous silica from a dendrimer template followed by loading a platinum metal into the silica matrix.

Tetraethyl orthosilicate (1.02 g) was slurried into a 1-propanol/DAB-Am-64 solution (1.60 g) consisting of 0.25 grams of dendrimer per gram of solution. Anhydrous methanol (0.57 g) was added to the TEOS/dendrimer/1-propanol mixture before adding demonized water (0.25 g). The resulting mixture was aged for 12 hours in a closed container at 70° C. (343 K). The resulting precipitate was oven-dried at 100° C. (373 K) for 20 hours.

The dried solid (approximately 0.3 g) was heated in a ½-inch inner diameter quartz U-tube reactor under flowing nitrogen for 1 hour at 530° C. (803 K). After cooling the sample to room temperature in a helium atmosphere, the solid was heated under flowing air to a temperature of 560° C. (833 K), which was maintained for a period of 2 hours. The calcined solid was then contacted with a saturated aqueous solution of H₂PtCl₆. The solids were impregnated with the platinum-ion solution to incipient wetness and subsequently reduced under flowing hydrogen in a ¼-inch inner diameter quartz U-tube reactor at 450° C. (723 K) for 2 hours. FIG. 8 shows a TEM of the resulting material indicating that metal particle size was consistent with void size.

### Example 5

### Preparation of Laminar and Cubic Arrangements of Dendrimers Within a Zirconium Phosphate Matrix

This example yields both laminar (as in Example 2) and cubic arrangements of dendrimers within a host matrix, in this case zirconium phosphate. The so-called “generation zero” DAB dendrimer (most commonly known as putrescine) was also employed.

Commercial, amorphous zirconium phosphate (20 g) from Southern Ionics Inc. was crystallized into an alpha zirconium phosphate (α-ZrP) by contacting the solid with concentrated phosphoric acid (100 mL) in a closed Teflon vessel at 100° C. for 4 days. Upon centrifugation and rinsing several times with distilled water, the α-ZrP was stored in a closed vial until use.

The α-ZrP (200 mg) was contacted with deionized water (6 mL) and variable amounts of dendrimer for 11 days at room temperature. The resulting solid was washed twice with H₂O and centrifuged. The solid at the bottom of the centrifuge tubes was re-suspended in methanol, centrifuged, and dried at room temperature for two days in a open container.

XRD analysis showed that the resulting solids comprised laminar and cubic forms of α-ZrP having dendrimers entrapped therein. A second metal such as a transition metal can be added to the entrapped dendrimers to produce α-ZrP with embedded metal and metal oxide clusters in accordance with the procedure described in Example 2.

### Further Examples

The present invention is further exemplified in recent publications by the present inventors including: Larsen et al., “Amine Dendrimers as Templates for Amorphous Silicas,” J. Phys. Chem., 104, 4840-43 (2000); Larsen et al., “Use of Polypropyleneimine Tetrahexacontaamine (DAB-Am-64) Dendrimer as a Single-Molecule Template to Produce Mesoporous Silicas,” Chem. Mater., 12, 1513-15 (2000); Larsen et al., “Facile Sol-Gel Synthesis of Porous Silicas Using Poly(propylene)imine Dendrimers as Templates,” J. Mater. Res., 15, 1842-48 (2000); Larsen et al., “Trapping Dendrimers in Inorganic Matrices: DAB-Am-n/Zinc Arsenate Composites,” Chem. Mater., 13, 4077-82 (2001); and Velarde-Ortiz et al., “A Poly(propylene imine) (DAB-Am-64) Dendrimer as Cu²⁺ Chelator for the Synthesis of Copper Oxide Clusters Embedded in Sol-Gel Derived Matrixes,” Chem. Mater., 14, 858-66 (2002), all of which are hereby incorporated herein in their entirety.

The present invention is not limited to the above embodiments and can be variously modified. The above description of the preferred embodiments, including the Examples, is intended only to acquaint others skilled in the art with the invention, its principles, and its practical application so that others skilled in the art may adapt and apply the invention in its numerous forms, as may be best suited to the requirements of a particular use.

With reference to the use of the word(s) comprise or comprises or comprising in this entire specification (including the claims below), Applicants note that unless the context requires otherwise, those words are used on the basis and clear understanding that they are to be interpreted inclusively, rather than exclusively, and that Applicants intend each of those words to be so interpreted in construing this entire specification.

What is claimed:

1. A method for preparing a porous solid comprising metal or metal oxide clusters embedded in an inorganic matrix, the method comprising:
combining a dendrimer, metal ions, a sol-gel precursor and a solvent to form a gel containing a chelated metal ion-dendrimer complex; and
heating the gel to thermally decompose the dendrimer and produce the porous solid comprising the inorganic matrix having metal or metal oxide clusters embedded therein.

2. A method as set forth in claim 1 wherein the dendrimer comprises at least a second generation polyamine dendrimer.

3. A method as set forth in claim 2 wherein the dendrimer comprises a PAMAM or a DAB-Am-n dendrimer.

4. A method as set forth in claim 3 wherein the dendrimer comprises DAB-Am-64.

5. A method as set forth in claim 2 wherein the metal ion comprises a metal having an affinity for amine ligands.

6. A method as set forth in claim 5 wherein the metal ion comprises a transition metal.

7. A method as set forth in claim 6 wherein the metal ion comprises a transition metal selected from the group consisting of copper, zinc, nickel, platinum, palladium, cobalt, iron, silver and gold.

8. A method as set forth in claim 1 wherein the sol-gel precursor comprises a metal or a metalloid selected from the group consisting of silica, titanium, zirconium, vanadium and aluminum.

9. A method as set forth in claim 8 wherein the sol-gel precursor comprises a metal or a metalloid alkoxide.

10. A method as set forth in claim 9 wherein the sol-gel precursor is tetraethylorthosilicate.

11. A method as set forth in claim 1 wherein the dendrimer is combined with the sol-gel precursor in the solvent to form a solution comprising a colloidal dendrimer matrix and the solution is combined with a second solution comprising the metal ions.

12. A method as set forth in claim 1 wherein the dendrimer is combined with the metal ions in the solvent to form a solution comprising the chelated metal ion-dendrimer complex and the solution is combined with a second solution comprising the sol-gel precursor.

13. A method as set forth in claim 12 wherein the solution comprising the chelated metal ion-dendrimer complex and the sol-gel precursor solution comprise an alcohol solvent.

14. A method as set forth in claim 13 wherein the alcohol solvent in the solution comprising the chelated metal ion-dendrimer complex and in the sol-gel precursor solution are independently selected from the group consisting of methanol, ethanol, propanol and butanol.

15. A method as set forth in claim 1 wherein solvent is removed from the gel to form a gel precipitate comprising the chelated metal ion-dendrimer complex and the gel precipitate is thereafter heated to thermally decompose the dendrimer and produce the porous solid comprising metal or metal oxide clusters embedded in the inorganic matrix.

16. A method as set forth in claim 16 wherein solvent is removed from the gel by aging the gel in an open or closed container at a temperature of from about 40° C. to about 90° C.

17. A method as set forth in claim 16 wherein solvent is removed from the gel by heating the gel to a temperature of from about 100° C. to about 120° C.

18. A method as set forth in claim 17 wherein the gel precipitate is heated to a temperature of at least about 500° C.

19. A method as set forth in claim 18 wherein the gel precipitate is heated to a temperature of from about 500° C. to about 800° C.

20. A method as set forth in claim 18 wherein the gel precipitate is triturated prior to heating.

21. A method as set forth in claim 20 wherein the triturated gel precipitate is heated in an oxygen-containing gas stream.

22. A method for preparing a porous solid having metal clusters supported thereon, the method comprising:
combining a dendrimer, a sol-gel precursor and a solvent to form a gel comprising the dendrimer;
heating the gel to thermally decompose the dendrimer and produce the porous solid; and
depositing the metal clusters onto-the porous solid.

23. A method as set forth in claim 22 wherein the metal clusters are deposited onto the porous solid by contacting the porous solid with a solution containing metal ions.

24. A method as set forth in claim 23 wherein the contacting of the porous solid with a solution containing metal ions is conducted using an incipient wetness impregnation technique.

25. A porous inorganic solid comprising metal clusters, the porous inorganic solid having spheroidal pores having a diameter from about 10 to about 40 angstroms, the spheroidal pores having a pore size distribution such that the diameter of at least about 95% of the spheroidal pores is within 0.5 nm of the average diameter of the spheroidal pores.

26. A porous inorganic solid as set froth in claim 25 wherein the metal clusters are embedded in the solid.

27. An inorganic solid as set forth in claim 25 having spheroidal pores having a diameter from about 15 to about 30 angstroms.

28. An inorganic solid as set forth claim 25 wherein the solid has a pore volume of at least about 0.2 cc/g.

29. An inorganic solid as set forth in claim 28 wherein the solid has a pore volume of from about 0.2 cc/g to about 2.0 cc/g.

30. An inorganic solid as set forth in claim 28 wherein at least about 60% of the pore volume is attributable to spheroidal pores having a diameter of from about 10 to about 40 angstroms.

31. An inorganic solid as set forth in claim 26 wherein the metal clusters have a particle size distribution such that 95% of the clusters have a diameter from about 1 nm to about 5 nm.

32. An inorganic solid as set forth in claim 31 wherein the metal clusters have a particle size distribution such that the diameter of 95% of the clusters is within 0.5 nm of the average cluster diameter.

33. An inorganic solid as set forth in claim 26 wherein the clusters comprise a transition metal.

34. An inorganic solid as set forth in claim 33 wherein the clusters comprise a transition metal selected from the group consisting of copper, zinc, nickel, platinum, palladium, cobalt, iron, silver and gold.
